(19) United States
(12) Patent Application Publication
(10) Pub. No.: US 2025/0392078 A1
(43) Pub. Date: Dec. 25, 2025

(54) MISPLUG-PROOF SOCKET

(71) Applicant: HUIHONG TECHNOLOGY (THAILAND) CO., LTD., Rayong (TH)

(72) Inventor: Zheng Shaotong, Yueqing, Zhejiang (CN)

(73) Assignee: HUIHONG TECHNOLOGY (THAILAND) CO., LTD., Rayong (TH)

(21) Appl. No.: 18/909,409

(22) Filed: Oct. 8, 2024

(30) Foreign Application Priority Data
May 7, 2024 (CN) 2024209760235

(51) Int. Cl. H01R 13/64

(52) U.S. Cl. CPC H01R 13/64

(57) ABSTRACT

The aspects of the disclosed embodiments are directed to a misplug-proof socket, including a housing and socket holes formed on top of the housing for inserting a plug, wherein a misplug-proof protection structure is arranged in the socket holes; the socket holes have a neutral wire hole, a live wire hole and an earth wire hole; the protection structure includes a protection plate covering the opening direction of the earth wire hole and a driving member for driving the protection plate to rotate; the driving member has an elastic restoring force and is rotatably connected to the housing; and the protection plate has a protection state of covering the earth wire hole and a counter-clockwise rotation shifted state when a plug is inserted. The misplug-proof socket can overcome the defect in the prior art that children misplug a socket hole and results in a casualty accident.

### TECHNICAL FIELD

The present utility model relates to the technical field of sockets, and specifically relates to a misplug-proof socket.

### BACKGROUND

With the development of economy and technology and the improvement of people's living standards, more and more electrical appliances are used in people's homes, and thus more and more sockets are used. The structure of a common socket generally includes a housing and electrodes within the housing which are made of a metal material and matched with prongs of a plug, and socket holes are formed in the housing at positions corresponding to the electrodes. However, most of the existing sockets are in a state of being ready for electricity, that is, the socket holes are not closed and in an open state. Children at home are full of curiosity and often take things to poke the socket holes, and if the things are made of a conductive material, there is a high risk of casualties.

### SUMMARY

In view of the above, to overcome the defect in the prior art that children misplug a socket hole and results in a casualty accident, the present utility model provides a socket capable of preventing children from misplugging.

The present utility model provides a misplug-proof socket, including a housing and socket holes formed on top of the housing for inserting a plug, wherein a misplug-proof protection structure is arranged in the socket holes; the socket holes include a neutral wire hole, a live wire hole and an earth wire hole; the protection structure includes a protection plate covering the opening direction of the earth wire hole and a driving member for driving the protection plate to rotate; the driving member has an elastic restoring force and is rotatably connected to the housing; and the protection plate has a protection state of covering the earth wire hole and a counter-clockwise rotation shifted state when a plug is inserted.

Further, the protection structure includes an auxiliary plate arranged in the housing; the driving member includes a hinge rod arranged on the auxiliary plate or the protection plate and a connecting shaft arranged on the other one and matched with the hinge rod; and an elastic restoring member is arranged between the hinge rod and the connecting shaft.

Further, the hinge rod penetrates through the auxiliary plate; the connecting shaft is arranged on the protection plate; the elastic restoring member is a torsion spring; and the torsion spring sleeves two ends of the hinge rod.

Further, a buckling device is arranged between the protection plate and the auxiliary plate; and the buckling device includes a buckling block arranged on the auxiliary plate or the protection plate and a buckling groove arranged on the other one and matched with the buckling block.

Further, the protection structure further includes an anti-insertion component arranged in the neutral wire hole and the live wire hole; the anti-insertion component includes a first stop block covered in the neutral wire hole and a second stop block covered in the live wire hole; and the auxiliary plate is provided with a first elastic member for assisting the first stop block to move and a second elastic member for assisting the second stop block to move.

Further, the first elastic member includes a first positioning block fixed on the auxiliary plate and a first spring arranged between the first positioning block and the first stop block; and the second elastic member includes a second positioning block fixed on the auxiliary plate and a second spring arranged between the second positioning block and the second stop block.

Further, a first positioning bead engaged with the first spring is arranged at a position where the first stop block is connected to the first spring; and a second positioning bead engaged with the second spring is arranged at a position where the second stop block is connected to the second spring.

Further, the housing includes a base and a cover plate; a waterproof protection film is arranged between the base and the cover plate; and the waterproof protection film covers the neutral wire hole, the live wire hole and the earth wire hole.

The technical solution of the present utility model has the following advantages:
1. According to the misplug-proof socket provided by the present utility model, the socket holes include the neutral wire hole, the earth wire hole and the live wire hole, and the earth wire hole is provided with the protection plate and the driving member for driving the protection plate to rotate and shift for inserting a plug. When an external plug is inserted, the plug will press the protection plate to make the driving member rotate. When the plug is pulled out, due to the elastic restoring force of the driving member, the protection plate will be driven to switch back to the protection state from the shifted state. Then, the protection plate covers the earth wire hole, to prevent an external object from being inserted into the earth wire hole.
2. According to the misplug-proof socket provided by the present utility model, the protection structure includes the auxiliary plate; the auxiliary plate is arranged above the earth wire hole, the live wire hole and the neutral wire hole; a circular hole is formed in the auxiliary plate; the hinge rod penetrates through the circular hole; and a perforation is also formed in the connecting shaft. In the process of installation, the hinge rod first needs to pass through the circular hole, then one end of the hinge rod facing away from the circular hole penetrates through a perforation in the protection plate, and then the torsion spring is arranged in a sleeving manner between two opposite connecting shafts, so that the hinge rod has an elastic restoring force.
3. According to the misplug-proof socket provided by the present utility model, when the protection plate is switched back to the protection state from the shifted state, the protection plate rotates clockwise; and when the buckling groove on the protection plate is engaged with the buckling block, the protection plate stops rotating, so the rotation angle of the protection plate can be effectively limited by the arrangement of the buckling block.

### BRIEF DESCRIPTION OF DRAWINGS

To more clearly illustrate the specific implementations of the present utility model or technical solutions in the prior art, the following is a brief description of the drawings required to be used in the description of the specific implementations or the prior art. It is obvious that the drawings described below are some implementations of the present utility model. For those of ordinary skill in the art, other drawings may be obtained according to the drawings without creative work.

FIG. 1 is a schematic diagram of the overall structure of a socket;

FIG. 2 is a schematic structural diagram of the socket with a cover plate removed;

FIG. 3 is an enlarged view of Part A in FIG. 2; and

FIG. 4 is a structural diagram of the socket covered with a waterproof protection film.

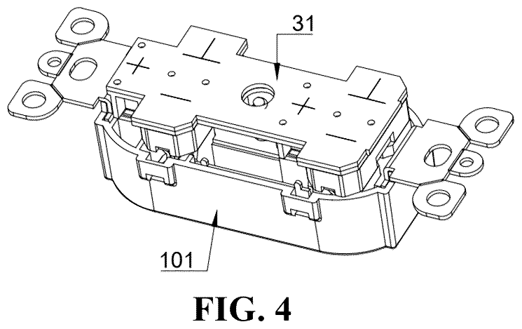

### REFERENCE SYMBOLS IN THE DRAWINGS

1. Housing; 101. Base; 102. Cover plate; 11. First elastic member; 111. First positioning block; 112. First spring; 12. Second elastic member; 121. Second positioning block; 122. Second spring; 13 First positioning bead; 14. Second positioning bead; 2. Socket hole; 21. Neutral wire hole; 22. Live wire hole; 23. Earth wire hole; 3. Protection plate; 31. Waterproof protection film; 4. Driving member; 5. Auxiliary plate; 6. Hinge rod; 61. Connecting shaft; 7. Torsion spring; 8. Buckling block; 81. Buckling groove; 9. First stop block; and 91. Second stop block.

### DETAILED DESCRIPTION

The technical solution of the present utility model will be described clearly and completely in combination with the accompany drawings below. It is obvious that the described embodiments are part but not all of the embodiments of the present utility model. Based on the embodiments of the present utility model, all other embodiments obtained by those of ordinary skill in the art without creative work fall within the scope of protection of the present utility model.

In the description of the present utility model, it is to be noted that the directions or position relationships indicated by the terms “center”, “top”, “bottom”, “left”, “right”, “vertical”, “horizontal”, “inside”, “outside”, etc., are directions or position relationships indicated based on the drawings only for the purpose of describing the present utility model and simplifying the description, rather than indicating or implying that the devices or elements indicated must have specific directions or be constructed and operated in specific directions, and therefore cannot be construed as limitations to the present utility model. In addition, the terms “first”, “second” and “third” are used only for descriptive purposes and cannot be understood as indicating or implying relative importance.

In the description of the present utility model, it is to be noted that, unless otherwise specified and defined, the terms “installation”, “linkage” and “connection” should be understood in a broad sense, e.g., as a fixed connection, as a removable connection, or as an integrated connection; as a mechanical connection, or as an electrical connection; as a direct connection, or as an indirect connection through an intermediate medium, or as an internal communication between two elements. The meanings of the above terms in the present utility model may be understood by those of ordinary skill in the art in specific circumstances.

In addition, the technical features involved in different implementations of the present utility model described below may be combined with each other as long as they do not constitute a conflict with each other.

### Embodiments

This embodiment provides a misplug-proof socket, including a housing 1 and socket holes 2 formed on top of the housing 1 for inserting a plug. A misplug-proof protection structure is arranged in the socket holes 2. The socket holes 2 include a neutral wire hole 21, a live wire hole 22 and an earth wire hole 23. The protection structure includes a protection plate 3 covering the opening direction of the earth wire hole 23 and a driving member 4 for driving the protection plate 3 to rotate. The driving member 4 has an elastic restoring force and is rotatably connected to the housing 1. The protection plate 3 has a protection state of covering the earth wire hole 23 and a counter-clockwise rotation shifted state when a plug is inserted.

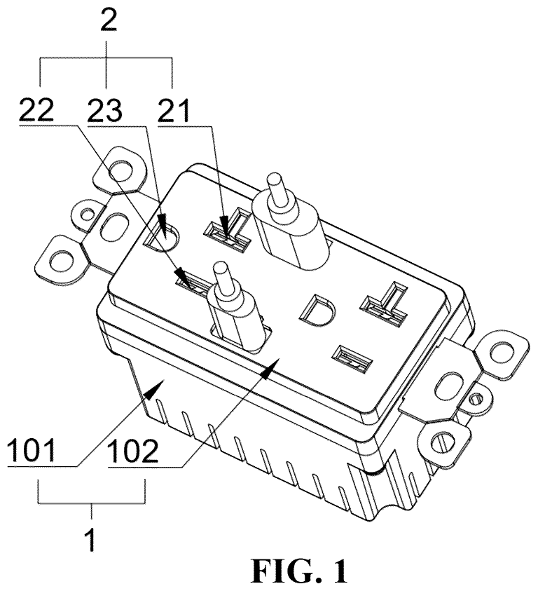

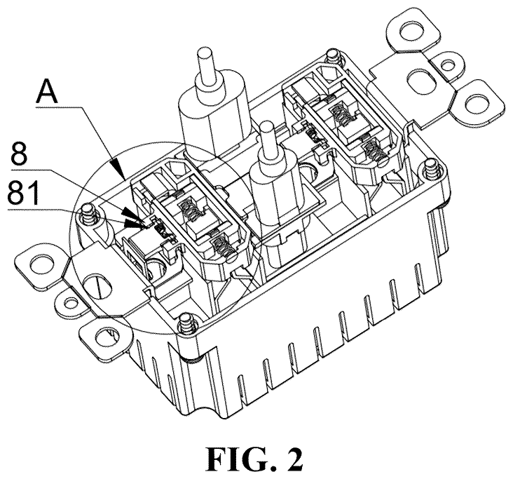

The specific improvement of the above is: as shown in FIG. 1 and FIG. 2, compared with the prior art, the socket holes 2 include the neutral wire hole 21, the earth wire hole 23 and the live wire hole 22, and the earth wire hole 23 is provided with the protection plate 3 and the driving member 4 for driving the protection plate 3 to rotate and shift for inserting a plug. When an external plug is inserted, the plug will press the protection plate 3 to make the driving member 4 rotate. When the plug is pulled out, due to the elastic restoring force of the driving member 4, the protection plate 3 will be driven to switch back to the protection state from the shifted state. Then, the protection plate 3 covers the earth wire hole 23, to prevent an external object from being inserted into the earth wire hole 23.

Based on the above embodiment, the protection structure includes an auxiliary plate 5 arranged in the housing 1; the driving member 4 includes a hinge rod 6 arranged on the auxiliary plate 5 or the protection plate 3 and a connecting shaft 61 arranged on the other one and matched with the hinge rod 6; and an elastic restoring member is arranged between the hinge rod 6 and the connecting shaft 61.

Based on the above embodiment, the hinge rod 6 penetrates through the auxiliary plate 5; the connecting shaft 61 is arranged on the protection plate 3; the elastic restoring member is a torsion spring 7; and the torsion spring 7 sleeves two ends of the hinge rod 6.

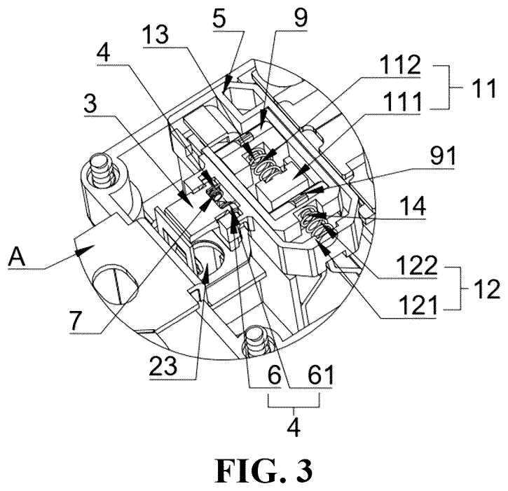

The specific improvement of the above is: as shown in FIG. 3, the protection structure includes the auxiliary plate 5; the auxiliary plate 5 is arranged above the earth wire hole 23, the live wire hole 22 and the neutral wire hole 21; a circular hole is formed in the auxiliary plate 5; the hinge rod 6 penetrates through the circular hole; and a perforation is also formed in the connecting shaft 61. In the process of installation, the hinge rod 6 first needs to pass through the circular hole, then one end of the hinge rod 6 facing away from the circular hole penetrates through a perforation in the protection plate 3, and then the torsion spring 7 is arranged in a sleeving manner between two opposite connecting shafts 61, so that the hinge rod 6 has an elastic restoring force.

Based on the above embodiment, a buckling device is arranged between the protection plate 3 and the auxiliary plate 5; and the buckling device includes a buckling block 8 arranged on the auxiliary plate 5 or the protection plate 3 and a buckling groove 81 arranged on the other one and matched with the buckling block 8.

The specific improvement of the above is: as shown in FIG. 2, when the protection plate 3 is switched back to the protection state from the shifted state, the protection plate 3 rotates clockwise; and when the buckling groove 81 on the protection plate 3 is engaged with the buckling block 8, the protection plate 3 stops rotating, so the rotation angle of the protection plate 3 can be effectively limited by the arrangement of the buckling block 8.

Based on the above embodiment, the protection structure further includes an anti-insertion component arranged in the neutral wire hole 21 and the live wire hole 22; the anti-insertion component includes a first stop block 9 covered in the neutral wire hole 21 and a second stop block 91 covered in the live wire hole 22; and the auxiliary plate 5 is provided with a first elastic member 11 for assisting the first stop block 9 to move and a second elastic member 12 for assisting the second stop block 91 to move.

The specific improvement of the above is: as shown in FIG. 2 and FIG. 3, the protection structure further includes the anti-insertion component arranged in the neutral wire hole 21 and the live wire hole 22; the first stop block 9 is arranged above the neutral wire hole 21; the second stop block 91 is arranged above the live wire hole 22; and the first elastic member 11 and the second elastic member 12 are respectively arranged at the sides of the first stop block 9 and the second stop block 91. With the first elastic member 11, it can be ensured that, when a plug is pulled out, the first stop block 9 can move above the neutral wire hole 21 again to cover the neutral wire hole 21; and with the second elastic member 12, it can be ensured that, when a plug is pulled out, the second stop block 91 can move above the live wire hole 22 again to cover the live wire hole 22.

Based on the above embodiment, the first elastic member 11 includes a first positioning block 111 fixed on the auxiliary plate 5 and a first spring 112 arranged between the first positioning block 111 and the first stop block 9; and the second elastic member 12 includes a second positioning block 121 fixed on the auxiliary plate 5 and a second spring 122 arranged between the second positioning block 121 and the second stop block 91.

The specific improvement of the above is: as shown in FIG. 3, the first spring 112 is connected to the first stop block 9 and the first positioning block 111, and the second spring 122 is connected to the second stop block 91 and the second positioning block 121. When a plug is inserted into the socket holes 2, the plug first contacts inclined guiding surfaces of the first stop block 9 and the second stop block 91. When the plug is further inserted downward, the first stop block 9 is continuously pushed to move towards one side close to the first positioning block 111, and the second stop block 91 is pushed to move towards one side close to the second positioning block 121.

Based on the above embodiment, a first positioning bead 13 engaged with the first spring 112 is arranged at a position where the first stop block 9 is connected to the first spring 112; and a second positioning bead 14 engaged with the second spring 122 is arranged at a position where the second stop block 91 is connected to the second spring 122.

The specific improvement of the above is: as shown in FIG. 3, with the first positioning bead 13, the end position of the first spring 112 can be effectively fixed, to prevent the first spring 112 from popping out during movement; and with the second positioning bead 14, the end position of the second spring 122 can be effectively fixed, to prevent the second spring 122 from popping out during movement.

Based on the above embodiment, the housing 1 includes a base 101 and a cover plate 102; a waterproof protection film 31 is arranged between the base 101 and the cover plate 102; and the waterproof protection film 31 covers the neutral wire hole 21, the live wire hole 22 and the earth wire hole 23.

The specific improvement of the above is: the waterproof protection film 31 is arranged above the neutral wire hole 21, the live wire hole 22 and the earth wire hole 23; the waterproof protection film 31 is provided with a through groove at a position corresponding to the neutral wire hole 21, the live wire hole 22 and the ground line hole 23; and the gap of the through groove is small and not easy for water to pass through. Therefore, with the waterproof protection film 31, a plug can be conveniently inserted into the socket holes 2 below the waterproof protection film 31, and water can be greatly insulated, so that the socket has an effective waterproof function.

It is obvious that the above embodiment is only an example for clear illustration, rather than a limitation on the implementations. Those of ordinary skill in the art may make different forms of changes or variations based on the above description. It is not necessary and impossible to exhaustively list all the implementations here. Obvious changes or variations arising therefrom shall still fall within the scope of protection of the present utility model.

1. A misplug-proof socket, comprising a housing and socket holes arranged on top of the housing for inserting a plug, wherein a misplug-proof protection structure is arranged in the socket holes; the socket holes comprise a neutral wire hole, a live wire hole and an earth wire hole; the protection structure comprises a protection plate covering the opening direction of the earth wire hole and a driving member for driving the protection plate to rotate; the driving member has an elastic restoring force and is rotatably connected to the housing; and the protection plate has a protection state of covering the earth wire hole and a counter-clockwise rotation shifted state when a plug is inserted.

2. The misplug-proof socket according to claim 1, wherein the protection structure comprises an auxiliary plate arranged in the housing; the driving member comprises a hinge rod arranged on the auxiliary plate or the protection plate and a connecting shaft arranged on the other one and matched with the hinge rod; and an elastic restoring member is arranged between the hinge rod and the connecting shaft.

3. The misplug-proof socket according to claim 2, wherein the hinge rod penetrates through the auxiliary plate; the connecting shaft is arranged on the protection plate; the elastic restoring member is a torsion spring; and the torsion spring sleeves two ends of the hinge rod.

4. The misplug-proof socket according to claim 3, wherein a buckling device is arranged between the protection plate and the auxiliary plate; and the buckling device comprises a buckling block arranged on the auxiliary plate or the protection plate and a buckling groove arranged on the other one and matched with the buckling block.

5. The misplug-proof socket according to claim 1, wherein the protection structure further comprises an anti-insertion component arranged in the neutral wire hole and the live wire hole; the anti-insertion component comprises a first stop block covered in the neutral wire hole and a second stop block covered in the live wire hole; and the auxiliary plate is provided with a first elastic member for assisting the first stop block to move and a second elastic member for assisting the second stop block to move.

6. The misplug-proof socket according to claim 5, wherein the first elastic member comprises a first positioning block fixed on the auxiliary plate and a first spring arranged between the first positioning block and the first stop block; and the second elastic member comprises a second positioning block fixed on the auxiliary plate and a second spring arranged between the second positioning block and the second stop block.

7. The misplug-proof socket according to claim 6, wherein a first positioning bead engaged with the first spring is arranged at a position where the first stop block is connected to the first spring; and a second positioning bead engaged with the second spring is arranged at a position where the second stop block is connected to the second spring.

8. The misplug-proof socket according to claim 7, wherein the housing comprises a base and a cover plate; a waterproof protection film is arranged between the base and the cover plate; and the waterproof protection film covers the neutral wire hole, the live wire hole and the earth wire hole.
